(19) United States
(12) Patent Application Publication
(10) Pub. No.: US 2008/0229946 A1
(43) Pub. Date: Sep. 25, 2008

(54) PRINTING UNIT OF A WEB-FED PRINTING PRESS

(75) Inventor: Wolfgang KAESER, Mertingen (DE)

Correspondence Address: CROWELL & MORING LLP;INTELLECTUAL PROPERTY GROUP, P.O. BOX 14300, WASHINGTON, DC, 20044-4300, US

(73) Assignee: MAN Roland Druckmaschinen AG, Augsburg (DE)

(21) Appl. No.: 12/052,553

(22) Filed: Mar. 20, 2008

(30) Foreign Application Priority Data
Mar. 21, 2007 (DE) 10 2007 013 463.2

(51) Int. Cl. B41F 7/02

(52) U.S. Cl. 101/217

(57) ABSTRACT

A printing unit of a web-fed printing press is disclosed. The printing unit includes four printing couples where each printing couple includes a plate cylinder, a transfer cylinder, an inking system as well as, if applicable, a dampening system. The transfer cylinders of every two printing couples arranged horizontally next to one another which form a printing couple group, form a nip, through which a to-be-printed printing substrate can be conveyed. The center points of the transfer cylinders (rolling off one another) of every printing couple group each lie on a horizontally running line. Two printing couple groups offset from one another in the vertical direction are also offset from one another in the horizontal direction such that the print positions as well as the center points of the transfer cylinders and the plate cylinders of the printing couple groups are offset from one another in the horizontal direction.

This application claims the priority of German Patent Document No. 10 2007 013 463.2, filed Mar. 21, 2007, the disclosure of which is expressly incorporated by reference herein.

### BACKGROUND AND SUMMARY OF THE INVENTION

The invention relates to a printing unit of a web-fed printing press.

Printing units of web-fed printing presses that are known from practice have several printing couples, wherein each printing couple has a transfer cylinder, a plate cylinder, an inking system as well as, if applicable, a dampening system. Plate cylinders are also designated as engraving cylinders, and transfer cylinders are also called blanket cylinders. In addition, these types of printing units may feature impression cylinders, wherein an impression cylinder can cooperate with one or more transfer cylinders of different printing couples. The impression cylinders are also designated as satellite cylinders, which is why printing units with at least one impression cylinder are also called satellite printing units. In addition to satellite printing units that have impression cylinders, printing units that do not have any impression cylinders are known, wherein, in the case of printing units without impression cylinders, the transfer cylinders of two printing couples roll off one another.

The present invention relates to a printing unit of a web-fed printing press with four printing couples and consequently four transfer cylinders as well as four plate cylinders, but without an impression cylinder, wherein the transfer cylinders of every two printing couples, which are arranged horizontally next to one another and each form a print position, roll off one another. Printing couples arranged horizontally next to one another form a printing couple group. Two printing couple groups are positioned vertically one over the other. This type of printing unit is also called an 8-cylinder printing unit. In the area of each print position, a printing substrate is printed on both sides with a partial print image in a special printing ink.

When the printing substrate being printed exits a nip formed between two transfer cylinders (rolling off one another) of printing couples arranged horizontally next to one another, there is a danger that the printing substrate will begin to flutter. The cause of this can that be that a different quantity of printing ink is applied to the printing substrate via the transfer cylinders forming the nip so that the printing substrate adheres more strongly to one transfer cylinder of the nip. In order to counteract the fluttering of the printing substrate when exiting a print position, in the case of 8-cylinder printing units known from practice, center points of the transfer cylinders (rolling off one another) of printing couples arranged horizontally next to one another are offset from one another in the vertical direction. This may cause construction space problems on the printing unit.

Starting herefrom, the present invention is based on the objective of creating a novel printing unit of a web-fed printing press.

According to the invention, the center points of the transfer cylinders (rolling off one another) of every printing couple group each lie on a horizontally running line, so that the center points of the transfer cylinders of each printing couple group are not offset from one another in the vertical direction, wherein the two printing couple groups that are offset from one another in the vertical direction are also offset from one another in the horizontal direction in such a way that both the print positions as well as the center points of the transfer cylinders and the center points of the plate cylinders of the printing couple groups that are offset from one another in the vertical direction are offset from one another in the horizontal direction.

The advantage of the inventive printing unit is that plate cylinders can be arranged or positioned at a flatter angle relative to the transfer cylinders of the corresponding printing couples. On the one hand, this makes a larger surface area available on the plate cylinder for applying printing plates, and, on the other hand, a larger surface area is available on the plate cylinder for rolling off ink form rollers of an inking system as well as for rolling off dampening form rollers of a dampening system. Another advantage of the inventive printing unit is that the printing couple groups that are vertically offset from one another can be positioned in the vertical direction at a smaller distance from one another, whereby, on the one hand, construction space can be saved, and whereby, on the other hand, the fan-out effect that forms in the case of dampening-solution-based printing can be counteracted.

Preferred developments of the invention are yielded from the following description. Without being limited hereto, exemplary embodiments of the invention are explained in greater detail on the basis of the drawings.

### BRIEF DESCRIPTION OF THE DRAWINGS

FIG. 1 illustrates a printing unit of a web-fed rotary printing press according to the prior art.

FIG. 2 illustrates printing unit of a web-fed rotary printing press in accordance with the principles of the present invention.

### DETAILED DESCRIPTION OF THE DRAWINGS

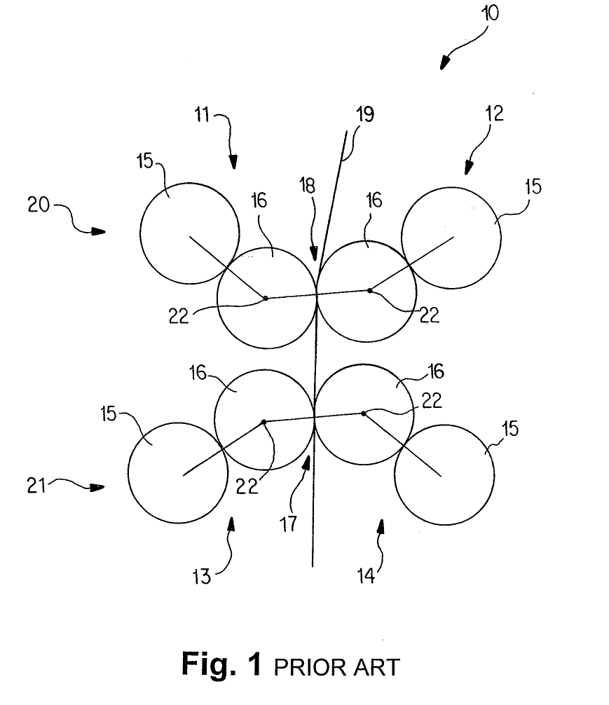

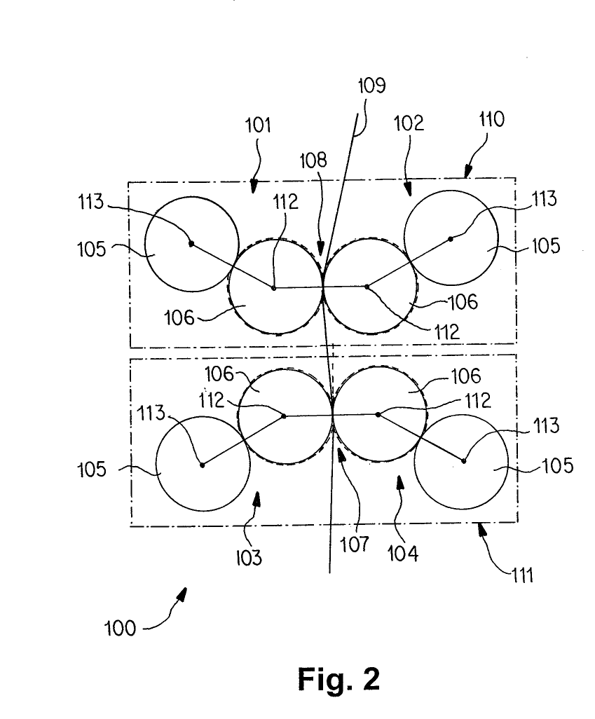

In the following, a printing unit of a web-fed printing press known from the prior art will be described first referring to FIG. 1, and then an inventive printing unit of a web-fed printing press will be described in detail making reference to FIG. 2.

Thus, FIG. 1 depicts very schematically a printing unit 10 known from the prior art of a web-fed rotary printing press, which features a total of four printing couples 11, 12, 13 and 14. Each of the printing couples 11, 12, 13 and 14 has a plate cylinder 15, a transfer cylinder 16, an inking system (not shown) as well as preferably a dampening system (also not shown).

The transfer cylinders 16 of every two printing couples 11, 12 or 13, 14 arranged horizontally next to one another, each forming a nip 17 or 18, roll off one another, wherein a web-shaped printing substrate 19 is conveyed through the nips 17, 18 for printing the printing substrate. Every two printing couples 11 and 12 or 13 and 14 arranged horizontally next to one another, whose transfer cylinders 16 form the nips 17 or 18 roll off one another, form a printing couple group 20 or 21. In FIG. 1 an upper printing couple group 20 includes printing couples 11 and 12, and a lower printing couple group 21 includes printing couples 13 and 14. The two printing couple groups 20 and 21 are offset from one another or spaced apart as viewed in the vertical direction.

According to the prior art, within each printing couple group 20 and 21, the center points 22 of the transfer cylinders 16 rolling off one another are offset from one another as viewed in the vertical direction. Therefore, in FIG. 1 the center point 22 of the transfer cylinder 16 of the printing couple 14 lies above the center point 22 of the transfer cylinder 16 of the printing couple 13. Likewise, the center point 22 of the transfer cylinder 16 of the printing couple 12 lies above the center point 22 of the transfer cylinder 16 of the printing couple 11. Because of horizontally offsetting the center points 22 of the transfer cylinders 16 (rolling off one another) of a printing couple group 20 or 21, construction space problems in particular arise on the printing unit 10.

FIG. 2 shows a schematic representation of an inventive printing unit 100 of a web-fed printing press. The printing unit 100 has four printing couples 101, 102, 103 and 104, whereby each of the printing couples 101, 102, 103 and 104 is comprised of a plate cylinder 105, a transfer cylinder 106, an inking system (not shown) as well as preferably a dampening system (also not shown). The printing unit 100 in FIG. 2 is consequently an 8-cylinder printing unit.

Again in the case of the inventive printing unit 100, transfer cylinders 106 of two printing couples 101 and 102 or 103 and 104 arranged horizontally next to one another roll off one another each forming a nip 107 or 108. Thus, in FIG. 2 the transfer cylinders 106 (rolling off one another) of the printing couples 101 and 102 form the nip 108 and the transfer cylinders 106 of the printing couples 103 and 104 form the nip 107. A web-shaped printing substrate 109 is moved through these nips 107, 108, in order to print the printing substrate in the area of each nip 107 or 108 on both sides with a partial print image in a special printing ink. Printing couples 101 and 102 or 103 and 104 arranged horizontally next to one another, whose transfer cylinders 106 roll off one another, again form a so-called printing couple group 110 or 111.

Within each printing couple group 110 and 111, the center points 112 of the transfer cylinders 106 (rolling off one another) of the printing couples 101 and 102 or 103 and 104 arranged horizontally next to one another lie on a horizontally running line, so that the center points 112 of the respective transfer cylinders 106 (rolling off one another) of each printing couple group 110 or 111 are not offset from one another in the vertical direction. Consequently, respective transfer cylinders 106 rolling off one another lie exactly next to one another horizontally without a vertical offset.

The two printing couple groups 110 and 111 that are offset from one another vertically are also offset from one another in the horizontal direction, and namely in such a way that the print positions 107 and 108 are offset from one another in the horizontal direction. In addition, the center points 112 of the transfer cylinders 106 (arranged above one another) of the two printing couple groups 110 and 110 are offset from one another in the horizontal direction. In addition, the center points 113 of the plate cylinders 105 (arranged above one another) of the two printing couple groups 110 and 111 are offset from one another in the horizontal direction.

At least one of the two printing couple groups 110 and 111 that are offset from one another in the vertical direction can be displaced in the horizontal direction so that all cylinders and rollers of this printing couple group cab be displaced jointly in the horizontal direction. It is preferred that both printing couple groups 110 and 111 that are offset from one another in the vertical direction can be displaced in the horizontal direction.

Because of the inventive principle of the printing unit 100 depicted in FIG. 2, the printing couple groups 110 and 111 that are offset from one another vertically can be positioned relative to one another at a smaller vertical distance than is possible in the prior art. This makes it possible to minimize construction space. In addition, the risk of a fan-out effect that forms in the case of dampening-solution-based printing is counteracted since the two print positions 107 and 108 move closer together. A further advantage of the inventive printing unit 100 is that the plate cylinders 105 can be positioned with a relatively obtuse angle to the transfer cylinders 106. As a result, on the one hand, a larger surface area is available on the plate cylinders 105 for any printing plate change being performed, and, on the other hand, a larger surface area is available for ink form rollers (not shown) that roll off the plate cylinders 105 as well as for any dampening form rollers.

### LIST OF REFERENCE NUMERALS

10 Printing unit
11 Printing couple
12 Printing couple
13 Printing couple
14 Printing couple
15 Plate cylinder
16 Transfer cylinder
17 Nip
18 Nip
19 Printing substrate
20 Printing couple group
21 Printing couple group
22 Center point
100 Printing unit
101 Printing couple
102 Printing couple
103 Printing couple
104 Printing couple
105 Plate cylinder
106 Transfer cylinder
107 Nip
108 Nip
109 Printing substrate
110 Printing couple group
111 Printing couple group
112 Center point
113 Center point

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A printing unit of a web-fed printing press with four printing couples, wherein each printing couple is comprised of a plate cylinder, a transfer cylinder, an inking system as well as, if applicable, a dampening system, and wherein the transfer cylinders of every two printing couples arranged horizontally next to one another which form a printing couple group, roll off one another to form a nip through which a to-be-printed printing substrate is conveyable, wherein center points of the transfer cylinders rolling off one another of every printing couple group each lie on a horizontally running line, so that the center points of the transfer cylinders of each printing couple group are not offset from one another in a vertical direction, and wherein two printing couple groups that are offset from one another in the vertical direction are also offset from one another in a horizontal direction in such a way that print positions, center points of the transfer cylinders, and center points of the plate cylinders of the printing couple groups that are offset from one another in the vertical direction are offset from one another in the horizontal direction.

2. The printing unit according to claim 1, wherein at least one of the two printing couple groups offset from one another in the vertical direction is displaceable in the horizontal direction.

3. The printing unit according to claim 2, wherein both of the two printing couple groups offset from one another in the vertical direction are displaceable in the horizontal direction.

4. A printing unit of a web-fed printing press, comprising:
a first printing couple group with opposed transfer cylinders, wherein a centerpoint of each of the opposed transfer cylinders lies on a first horizontal line; and
a second printing couple group with opposed transfer cylinders, wherein a centerpoint of each of the opposed transfer cylinders lies on a second horizontal line;
wherein the first printing couple group is arranged vertically above the second printing couple group.

5. The printing unit according to claim 4, wherein a print position of the first printing couple group is horizontally offset from a print position of the second printing couple group.

6. The printing unit according to claim 4, wherein the center point of one of the opposed transfer cylinders of the first printing couple group is horizontally offset from the center point of one of the opposed transfer cylinders of the second printing couple group that is arranged directly vertically below the one of the opposed transfer cylinders of the first printing couple group.

7. The printing unit according to claim 4, wherein a center point of a plate cylinder of the first printing couple group is horizontally offset from a center point of a plate cylinder of the second printing couple group that is arranged directly vertically below the plate cylinder of the first printing couple group.
